(19) United States
(12) Patent Application Publication
(10) Pub. No.: US 2026/0057884 A1
(43) Pub. Date: Feb. 26, 2026

(54) GENERATING UNIFIED TEXT USING SPEECH RECOGNITION MODELS FOR CONVERSATIONAL AI SYSTEMS AND APPLICATIONS

(71) Applicant: NVIDIA Corporation, Santa Clara, CA (US)

(72) Inventors: Harishchandra Dubey, Snohomish, WA (US); Myungjong Kim, Milpitas, CA (US); Utkarsh Vaidya, Jabalpur (IN); Oluwatobi Olabiyi, Falls Church, VA (US); Nourchene Ferchichi, Dresden (DE)

(21) Appl. No.: 18/811,559

(22) Filed: Aug. 21, 2024

(51) Int. Cl. G10L 15/197; G06F 9/455; G10L 15/05; G10L 15/06

(52) U.S. Cl. CPC G10L 15/197; G06F 9/45558; G10L 15/05; G10L 15/063; G10L 2015/0635

(57) ABSTRACT

In various examples, generating unified text using speech recognition models for AI systems and applications is described herein. Systems and methods are disclosed that use a machine learning model that is trained to generate unified text associated with user speech, where the unified text includes punction marks, capitalizations of words, inverse text normalization formatting, end of sentence (EOS) detections, and/or end of utterance (EOU) detections. For instance, the machine learning model may receive audio data representing speech as input. The machine learning model may then process the audio data and, based at least on the processing, generate output data associated with the speech. In some examples, the output data may represent tokens, such as tokens associated with automatic speech recognition processing, punctuation and capitalization processing, EOS and/or EOU processing, and/or inverse text normalization processing. In such examples, the tokens may then be processed to generate the unified text.

### BACKGROUND

Automatic speech recognition (ASR) systems are used to process speech from users in order to convert the speech to text. However, the raw text that is output by the ASR systems is in spoken form which lacks reliability, such as by using spoken words (e.g., text stating “one hundred dollars” instead of “$100”), missing capitalization of words, and/or missing punction marks. As such, additional systems are often used to further process the raw text, such as a system that inserts punctuation into the text and/or corrects the text such that it is in capitalization form, and/or a system that converts the spoken form of the words to written form (e.g., performs inverse text normalization). Additionally, in some circumstances, such as when the text is being used by one or more downstream applications—such natural language understanding applications and/or machine translation applications—the text may additionally be processed using a system that identify ends of sentences and/or ends of utterances associated with the speech.

However, problems may arise when using such an architecture that includes multiple systems processing the audio data and/or the text in order to generate a final format of the text. For instance, each system may be prone to output errors, such as the ASR systems outputting text that includes incorrect words. Additionally, since these systems operate in a sequence, if an initial system in the sequence outputs an error—such as the ASR system—then the error may be propagated throughout the rest of the systems causing degradation in the outputs. Furthermore, since the systems operate in sequence by processing the outputs from preceding systems, the overall latency of the architecture increases based on the number of systems that are used to process the audio data. For example, each system may include a respective processing latency, where the overall latency of the architecture may be a sum of the latencies of the systems.

### SUMMARY

Embodiments of the present disclosure relate to generating unified text using speech recognition models for AI systems and applications. Systems and methods are disclosed that use a machine learning model that is trained to generate unified text associated with user speech, where the unified text includes punction marks, capitalizations of words, inverse text normalization (ITN) formatting, end of sentence (EOS) detections, and/or end of utterance (EOU) detections. For instance, the machine learning model may receive audio data representing user speech as input. In some examples, the audio data is initially processed before inputting into the machine learning model, such as to generate input data representing embeddings associated with frames of the audio data. The machine learning model may then process the audio data and/or the input data and, based at least on the processing, generate output data associated with the unified text. In some examples, the output data may represent tokens, such as tokens associated with automatic speech recognition (ASR) processing, punctuation and capitalization (PAC) processing, EOS processing, EOU processing, and/or ITN processing. In such examples, the tokens may then be processed to generate the unified text.

In contrast to conventional systems, the systems of the present disclosure may use a single machine learning model that generates the output data representing the unified text that includes the punction marks, the capitalizations of words, the ITN formatting, the EOS detections, and/or the EOU detections. As such, the systems of the present disclosure may reduce the number of systems, models, modules, applications, and/or other processing components needed to generate such text in a final format this is usable for other applications and/or users. As described herein, by reducing the number of processing components, the systems of the present disclosure may also reduce the number of errors associated with the processing, since it is just a single model that is prone to outputting errors instead of multiple processing components, and/or may reduce the overall latency associated with the processing.

### BRIEF DESCRIPTION OF THE DRAWINGS

The present systems and methods for generating unified text using speech recognition models for AI systems and applications are described in detail below with reference to the attached drawing figures, wherein:

FIG. 1A illustrates an example of a process for generating unified text using a machine learning model, in accordance with some embodiments of the present disclosure;

FIG. 1B illustrates an example of a machine learning model that may be trained to generate unified text, in accordance with some embodiments of the present disclosure;

FIG. 2 illustrates an example of generating sets of tokens for frames of audio data, in accordance with some embodiments of the present disclosure;

FIG. 3 illustrates an example of techniques that may be used to select tokens associated with a frame and/or a group of frames, in accordance with some embodiments of the present disclosure;

FIGS. 4A-4B illustrate examples of different types of processing that may be performed by a machine learning model, in accordance with some embodiments of the present disclosure;

FIG. 5A illustrates a data flow diagram illustrating a process for training a machine learning model to perform various types of processing, in accordance with some embodiments of the present disclosure;

FIG. 5B illustrates an example of generating ground truth data for training a machine learning model, in accordance with some embodiments of the present disclosure;

FIG. 6 illustrates an example of a system that may perform one or more of the processes described herein, in accordance with some embodiments of the present disclosure;

FIG. 7 illustrates a flow diagram showing a method for processing audio data using a machine learning model that performs ASR processing and ITN processing, in accordance with some embodiments of the present disclosure;

FIG. 8 illustrates a flow diagram showing a method for processing audio data using a machine learning model that performs ASR processing and EOS and/or EOU processing, in accordance with some embodiments of the present disclosure;

FIG. 9A is a block diagram of an example generative language model system suitable for use in implementing some embodiments of the present disclosure;

FIG. 9B is a block diagram of an example generative language model that includes a transformer encoder-decoder suitable for use in implementing some embodiments of the present disclosure;

FIG. 9C is a block diagram of an example generative language model that includes a decoder-only transformer architecture suitable for use in implementing some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed related to generating unified text using speech recognition models for AI systems and applications. For instance, a system(s) may generate, obtain, receive, determine, and/or retrieve audio data representing speech from a user. As described herein, the speech may be associated with an utterance, such as an utterance that includes “We will rent you a GPU. It will be one hundred dollars” (and/or any other utterance). In some examples, the audio data may then be preprocessed using one or more processing components, which may be referred to as an “audio processor(s)).” For example, the audio processor(s) may be configured to process the audio data in order to separate the audio data in audio frames. The audio processor(s) may then process the audio frames in order to generate features, such as mel-frequency spectrum features, Fourier transform features, and/or the any other type of audio features. Additionally, the audio processor(s) may further generate embeddings and/or vectors that then represent the features of the audio frames.

In examples where the audio data is preprocessed using the audio processor(s), input data representing the features, the embeddings, and/or the vectors may be input into a machine learning model. However, in other examples, the audio data may directly be input into the machine learning model, where the machine learning model then processes the audio data using one or more of the processes described herein with respect to the audio processor(s). For example, the machine learning model may include one or more encoders that are configured to process the audio data and generate the embeddings and/or the vectors associated with the audio frames of the audio data. In any of these examples, the machine learning model may be trained to perform various types of processing, such as ASR processing, PAC processing, EOS processing, EOU processing, and/or ITN processing to generate unified text that includes punctions marks, capitalizations, EOS indications, EOU indications, and/or ITN formatting.

For instance, based at least on processing the input data and/or the audio data, the machine learning model may be trained to generate output data representing tokens associated with the speech. In some examples, the tokens may be associated with the various types of processing for which the machine learning model is trained. For example, the tokens may include tokens (ASR tokens) associated the ASR processing that represent at least letters, portions of words, and/or words, tokens (PAC tokens) associated with PAC processing that represent punctuation marks (e.g., periods, commas, question marks, exclamation marks, etc.) and/or capital letters, tokens (EOS tokens) associated with EOS processing that represent symbols corresponding to ends of sentences, tokens (EOU tokens) associated with EOU processing that represent symbols corresponding to ends of utterances, and/or tokens (ITN tokens) associated with ITN processing that represent numbers, symbols associated with words (e.g., $ for dollar, ° for degree, etc.), and/or any other written word characters.

In some examples, the machine learning model may be trained to generate sets of tokens for each frame. For example, the machine learning model may generate a first set of tokens for a first frame, a second set of tokens for a second frame, a third set of tokens for a third frame, and/or so forth. In some examples, the machine learning model may be trained to generate sets of tokens for groups of frames (e.g., two frames, five frames, ten frames, etc.). For example, the machine learning model may generate a first set of tokens for a first group of frames, a second set of tokens for a second group of frames, a third set of tokens for a third group of frames, and/or so forth. In any of the examples, a set of tokens may include one or more tokens (e.g., each token) for which the machine learning model is trained to predict. For example, a set of tokens may include the ASR tokens, the PAC tokens, the EOS tokens, the EOU tokens, and/or the ITN tokens.

In some examples, the machine learning model may further be trained to generate output data representing probabilities associated with the tokens. For example, and for a set of tokens, the machine learning model may output a respective probability indicating a likelihood that a respective token is associated with a frame and/or a group of frames. In some examples, the probabilities may be associated with a range, such as 0 to 1, 0 to 100, and/or any other range of values.

In some examples, one or more processing components (and/or one or more decoders of the machine learning model) may then be configured to use the output data to generate unified text associated with the speech, which may be referred to as a “token processor(s).” As described herein, unified text may include text that includes punction marks, capitalizations, EOS symbols, EOU symbols, and/or ITN formatting (e.g., a normalized format, also referred to as “normalized text”). To generate the unified text, the token processor(s) may be configured to use the probabilities to select one or more tokens from each set of tokens and then use the selected tokens to generate the unified text. In some examples, to select the tokens, the token processor(s) may use a first technique (e.g., greedy decoding) that includes selecting a respective token that is associated with a highest probability from each set of tokens. The token processor(s) may then generate the unified text using the selected tokens. For example, the unified text may include the letters, parts of words, words, punctuation marks, capitalizations, EOS symbols, EOU symbols, numbers, words symbols, and/or the like associated with the selected tokens.

Additionally, or alternatively, in some examples, to select the tokens, the token processor(s) may use a second technique (e.g., beam search/flash decoding) to select a group of tokens that are associated with a number of highest probabilities from each set of tokens. In such examples, the token processor(s) may then use the groups of tokens selected from the sets of tokens to determine the unified text. For example, the token processor(s) may process the groups of tokens, along with the letters, parts of words, words, punctuation marks, capitalizations, EOS symbols, EOU symbols, numbers, and/or words symbols for which the tokens are associated, using one or more language models that are trained to output the unified text. While these examples describe the token processor(s) as processing the output data to generate the unified text, in other examples, the machine learning model may further use similar techniques to process the output data in order to generate the unified text (e.g., using one or more decoders).

While the examples above describe the machine learning model that is trained to perform ASR processing, PAC processing, EOU processing, EOS processing, and/or ITN processing, in other examples, the machine learning model may be trained to perform one or more of ASR processing, PAC processing, EOU processing, EOS processing, or ITN processing. For a first example, if the machine learning model is trained to perform ASR processing, EOU processing, and EOS processing, then the tokens output by the machine learning model may include ASR tokens, EOU tokens, and EOS tokens and the unified text may include the EOU symbols and the EOS symbols. For a second example, if the machine learning model is trained to perform ASR processing, PAC processing, and ITN processing, then the tokens output by the machine learning model may include ASR tokens, PAC tokens, and ITN tokens and the unified text may include punctuation marks, capitalizations, and be in a normalized format.

In some examples, the system(s) may use one or more techniques to train the machine learning model to generate the output data associated with the unified text. For example, the machine learning model may be trained to output the ASR tokens, the PAC tokens, the EOS tokens, the EOU tokens, and/or the ITN tokens. To train the machine learning model, the system(s) may generate, obtain, receive, determine, and/or retrieve training input data, such as audio data representing instances of speech (e.g., utterances). Additionally, the system(s) may generate, obtain, receive, determine, and/or retrieve ground truth data associated with the training input data. In some examples, the ground truth data may represent instances of unified text that correspond to the utterances. Additionally, or alternatively, in some examples, the ground truth data may represent the instances of unified text in tokenized form, such as including the tokens for which the machine learning model is being trained to predict.

The system(s) may then use various techniques to train the machine learning model using the training data (e.g., the training input data and corresponding ground truth data). For a first example, such as when the ground truth data represents the tokens, the machine learning model may process the training input data and, based at least on the processing, generate output data representing tokens. One or more training engines may then determine one or more losses based at least on comparing the output tokens to the ground truth tokens and update one or more parameters and/or weights of the machine learning model using loss(es). For a second example, such as when the ground truth data represents instances of unified text, the machine learning model may process the training input data and, based at least on the processing, generate unified text. The training engine(s) may then determine one or more losses based at least on comparing the output unified text to the ground truth unified text and update one or more parameters of the machine learning model using loss(es). While these are just a few example techniques for how the machine learning model may be trained, in other examples, the system(s) may train the machine learning model using additional and/or alternative techniques, which are described herein.

As described herein, the system(s) may use one or more techniques to generate the training data. For instance, in some examples, such as to generate enough training data to initially train the machine learning model, the system(s) may use one or more systems, models, modules, and/or the like to automatically generate the ground truth data. For example, the system(s) may use an ASR system, a PAC system, an EOU/EOS system, and/or an ITN system to generate unified text that includes the punctation marks, capitalizations, EOU symbols, EOS symbols, and/or is in normalized format. Additionally, or alternatively, in some examples, such as to generate training data to test an accuracy of the machine learning model, the system(s) may generate the ground truth data using user feedback.

In some examples, the machine learning model may include any type of model, neural network (e.g., a convolution neural network, a recurrent neural network, etc.), transformer, module, and/or processing component that is configured to perform one or more of the processes described herein. For example, the machine learning model may include any type of model that includes an encoder that is configured to initially process the audio data to generate audio embeddings and a decoder that that is configured to process the audio embeddings to generate the output data associated with the unified text. In such an example, the machine learning model may include a feedback loop between the decoder and encoder to ensure linguistic cues from partial text may be fed back into the encoder.

In some examples, various types of technologies may use the machine learning model to perform at least a portion of the processes described herein. For a first example, systems that use execute additional applications—such as natural language applications that are configured to interpret text (e.g., for one or more systems, such as a vehicle control system, a robotics control system, an avatar communications system, etc.), machine translation applications that are configured to translate text from a first language into a second language, and/or language model applications that are configured to process text—may use the machine learning model to generate the unified text that is input into these applications. In such an example, since the unified text may indicate the locations of ends of sentences and/or ends of utterances associated with speech, the systems may input the unified text into the applications using techniques that help improve the performance of the processing. For instance, the systems may input portions of the unified text into the applications based on the locations of the ends of sentences and/or the locations of the ends of utterances.

For a second example, systems that provide interactive applications—such as gaming applications, communications applications, and/or collaborative group applications—may use the machine learning model to perform one or more processes. For instance, the systems may receive audio data representing speech from a user of an interactive application. The systems may then process the audio using the machine learning model, such as by using one or more of the processes described herein, to generate unified text that is associated with the speech. Additionally, the systems may then provide the unified text to one or more devices of one or more users of the interactive application such that the device(s) is able to both output audio associated with the speech and display content associated with the unified text.

In some examples, the machine learning model may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems implementing one or more multi-modal models, systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

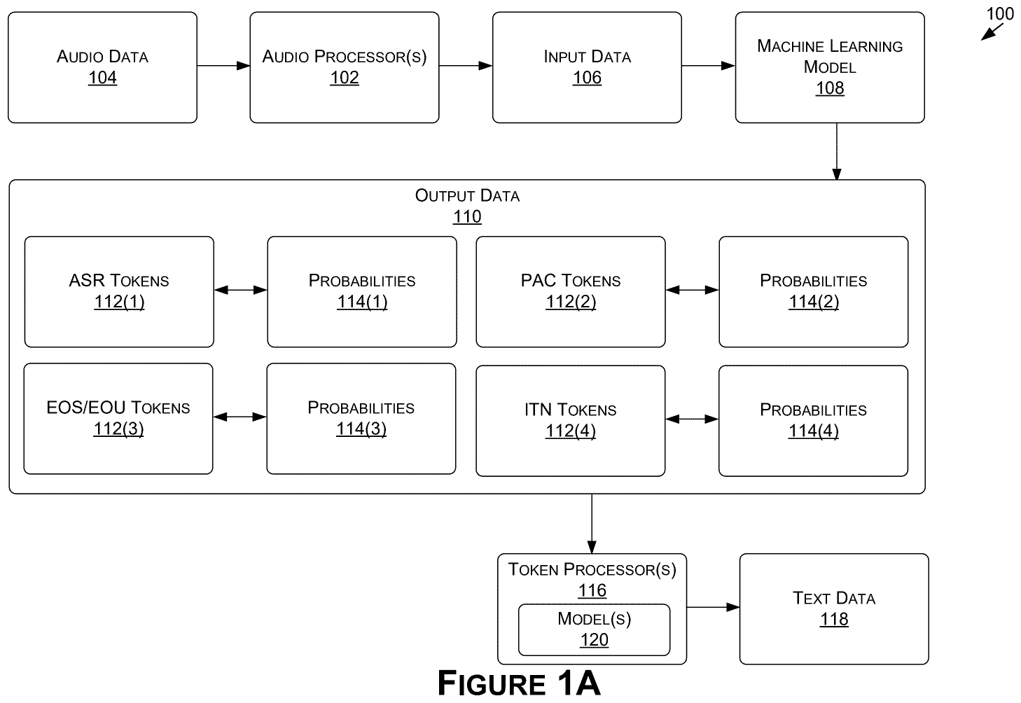

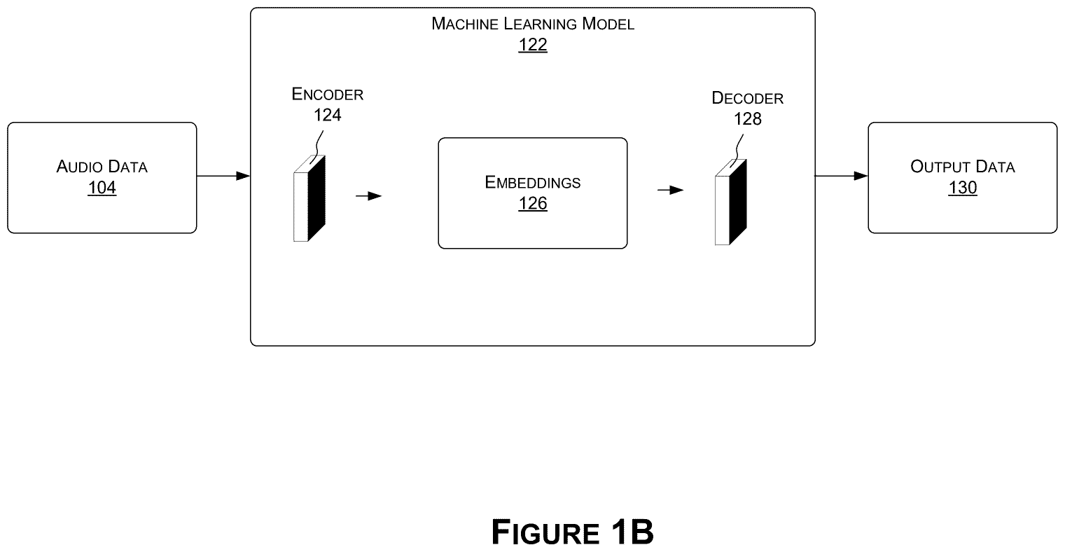

With reference to FIG. 1A, FIG. 1A illustrates an example of a process 100 for generating unified text using a machine learning model, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more audio processors 102 receiving audio data 104 representing speech. As described herein, the speech may be associated with an utterance, such as an utterance that includes “We will rent you a GPU. It will be one hundred dollars”. The process 100 may then include the audio processor(s) 102 processing the audio data 104 in order to generate input data 106 for a machine learning model 108. For example, the audio processor(s) 102 may be configured to process the audio data 104 in order to separate the audio data 104 into audio frames. As described herein, an audio frame may include any length, such as 25 milliseconds, 50 milliseconds, 75 milliseconds, and/or any other length portion of the audio data 104. The audio processor(s) 102 may then process the audio frames in order to generate features, such as mel-frequency spectrums features, Fourier transform features, and/or any other type of features representing the speech. Additionally, the audio processor(s) 102 may generate embeddings and/or vectors that then represent the features of the audio frames, where the input data 106 may represent the audio frames, the features, the embeddings, and/or the vectors.

As described herein, the audio processor(s) 102 may include any type of processing component that is configured to perform one or more of the processes described herein, such as one or more machine learning models, one or more neural networks, one or more encoders, one or more modules, one or more Fast-Fourier Transformation components, and/or the like. Additionally, while the example of FIG. 1A illustrates the audio processor(s) 102 as being separate from the machine learning model 108, in other examples, the machine learning model 108 may include the audio processor(s) 102. For example, and as illustrated by the example of FIG. 1B, the machine learning model 108 may include one or more encoders that are configured to perform at least a portion of the processing described herein with respect to the audio processor(s) 102.

The process 100 may then include the machine learning model 108 processing the input data 106 (and/or, in some examples, the audio data 104) and, based at least on the processing, generating output data 110 associated with the speech. In some examples, and as illustrated by the example of FIG. 1A, the output data 110 may represent at least tokens 112(1)-(4) (also referred to singularly as “token 112” or in plural as “tokens 112”) and probabilities 114(1)-(4) (also referred to singularly as “probability 114” or in plural as “probabilities 114”). In some examples, the tokens 112 may be associated with the various types of processing for which the machine learning model 108 is trained to perform. For example, the tokens 112 may include at least ASR tokens 112(1) associated with the ASR processing, PAC tokens 112(2) associated with PAC processing, EOS/EOU tokens 112(3) associated with EOS/EOU processing, and/or ITN tokens 112(4) associated with ITN processing.

In some examples, the tokens 112 associated with the different types of processing may represent unique types of text such that the machine learning model 108 is able to generate the unified text described herein. For instance, the ASR tokens 112(1) may represent at least letters, characters, sentences (or portions thereof), portions of words (subwords), and/or words such that the machine learning model 108 may perform ASR processing. Additionally, the PAC tokens 112(2) may represent at least punctuation marks (e.g., periods, commas, question marks, exclamation marks, etc.) and/or capital letters such that the machine learning model 108 may perform PAC processing. Furthermore, the EOS/EOU tokens 112(3) may represent at least one or more symbols associated with ends of sentences and/or one or more symbols associated with ends of utterances such that the machine learning model 108 may perform EOS/EOU processing. Moreover, the ITN tokens 112(4) may represent at least numbers, symbols associated with words (e.g., $ for dollar, ° for degree, etc.), and/or any other written word characters such that the machine learning model 108 may perform ITN processing.

In some examples, the machine learning model 108 may be trained to generate sets of tokens for each frame. For example, the machine learning model 108 may generate a first set of tokens 112 for a first frame, a second set of tokens 112 for a second frame, a third set of tokens 112 for a third frame, and/or so forth. In some examples, the machine learning model 108 may be trained to generate sets of tokens 112 for groups of frames (e.g., two frames, five frames, ten frames, etc.). For example, the machine learning model 108 may generate a first set of tokens 112 for a first group of frames, a second set of tokens 112 for a second group of frames, a third set of tokens 112 for a third group of frames, and/or so forth. In any of the examples, a set of tokens may include one or more tokens 112 (e.g., each token 112) for which the machine learning model 108 is trained to predict. For example, a set of tokens 112 may include the ASR tokens 112(1), the PAC tokens 112(2), the EOS/EOU tokens 112(3), and/or the ITN tokens 112(4).

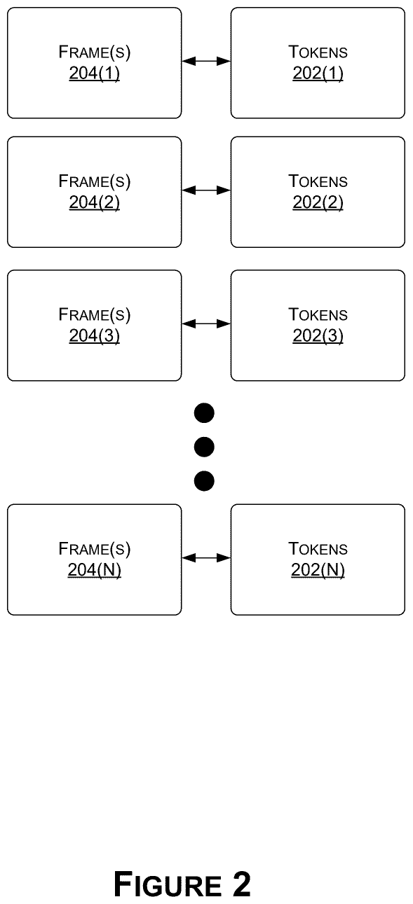

For instance, FIG. 2 illustrates an example of generating sets of tokens for frames of audio data, in accordance with some embodiments of the present disclosure. As shown, the machine learning model 108 may generate output data (e.g., the output data 110) that includes at least first tokens 202(1) associated with one or more first frames 204(1) of audio data (e.g., the audio data 104), second tokens 202(2) associated with one or more second frames 204(2) of the audio data, third tokens 202(3) associated with one or more third frames 204(3) of the audio data, and so forth until final tokens 202(N) associated with one or more final frames 204(N) of the audio data. As described herein, in some examples, one or more sets (e.g., each set) of the tokens 202(1)-(N) may include the ASR tokens 112(1), the PAC tokens 112(2), the EOS/EOU tokens 112(3), and/or the ITN tokens 112(N).

Referring back to the example of FIG. 1A, the probabilities 114 may indicate likelihoods that the tokens 112 are associated with the frame and/or group of frames. In some examples, the machine learning model 108 may be trained to generate a respective probability 114 associated with each of the tokens 112. However, in other examples, the machine learning model 108 may be trained to generate a respective probability for a group tokens 112. Additionally, in some examples, the probabilities 114 may be associated with a range, such as 0 to 1, 0 to 100, and/or any other range of values.

As further illustrated by the example of FIG. 1A, the process 100 may include one or more token processors 116 processing the output data 110 and, based at least on the processing, generating text data 118 representing unified text that is associated with the speech. For instance, the token processor(s) 116 may be configured to use the probabilities 114 to select one or more tokens 112 from each set of tokens 112 and then use the selected token(s) 112 to generate the unified text. In some examples, to select tokens 112, the token processor(s) 116 may use a first technique (e.g., greedy decoding) that includes selecting a respective token 112 that is associated with a highest probability 114 from each set of tokens 112. Additionally, or alternatively, in some examples, to select the tokens 112, the token processor(s) 116 may use a second technique (e.g., beam search/flash decoding) that includes selecting a group of tokens that are associated with a number of highest probabilities 114 from each set of tokens 112.

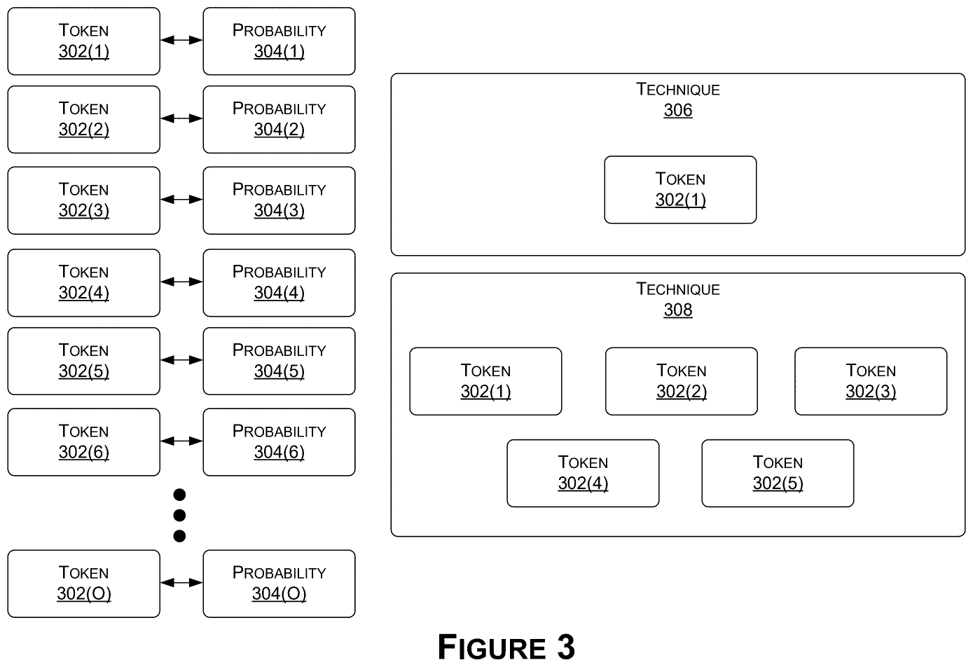

For instance, FIG. 3 illustrates an example of techniques that may be used to select tokens associated with a frame and/or a group of frames, in accordance with some embodiments of the present disclosure. As shown, tokens 302(1)-(O) (also referred to singularly as “token 302” or in plural as “tokens 302”) may be associated with probabilities 304(1)-(O) (also referred to singularly as “probability 304” or in plural as “probabilities 304”). In the example of FIG. 3, the tokens 302 may be arranged from the highest probability 304, which is associated with the first token 302(1), and in descending order of the probabilities 304 until the final token 302(O). As such, a first technique 306, such as a greedy decoding technique, may include selecting the first token 302(1) associated with the highest probability 304(1). Additionally, a second technique 308, such as beam search/flash decoding, may include selecting the group of tokens 302(1)-(5) associated with the five highest probabilities 304(1)-(5). While the example of FIG. 3 illustrates selecting the group as including five tokens 302(1)-(5) associated with the five highest probabilities 304(1)-(5), in other examples, the group may include any number of tokens 302 associated with any number of the highest probabilities 304.

Referring back to the example of FIG. 1A, the token processor(s) 316 may then use the selected tokens 112 to generate the unified text. For a first example, and for the first technique for selecting the tokens 112, the token processor(s) 116 may generate the unified text to include the letters, parts of words, words, punctuation marks, capitalizations, EOS symbols, EOU symbols, numbers, symbols associated with words, and/or the like associated with the selected tokens 112. For a second example, and for the second technique, the token processor(s) 116 may process the groups of tokens 112, along with the letters, parts of words, words, punctuation marks, capitalizations, EOS symbols, EOU symbols, numbers, symbols associated with words, and/or the like that are associated with the tokens 112, using one or more language models 120. Based at least on the processing, the language model(s) 120 may be configured to select a sequence of the tokens 112 that generates unified text that makes the most sense (e.g., includes proper language).

As described herein, by performing the process 100 of FIG. 1A, the unified text represented by the text data 118 may be associated with ASR processing, PAC processing, EOU/EOS processing, and/or ITN processing. For a first example, if the machine learning model 108 is trained to perform ASR processing and EOU/EOS processing, then the tokens 112 output by the machine learning model 108 may include ASR tokens 112(1) and the EOU/EOS tokens 112(3) and the unified text may include the EOU symbols and the EOS symbols. For a second example, if the machine learning model 108 is trained to perform ASR processing, PAC processing, and ITN processing, then the tokens 112 output by the machine learning model 108 may include ASR tokens 112(1), PAC tokens 112(2), and ITN tokens 112(4) and the unified text may include punctuation marks, capitalizations, and be in a normalized format.

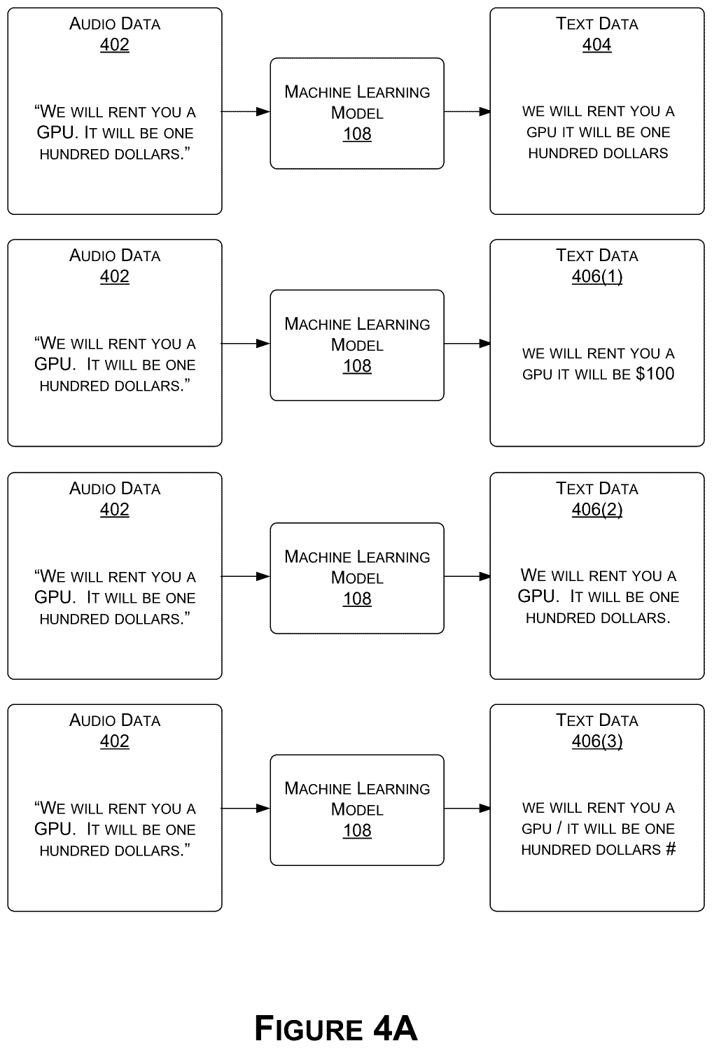

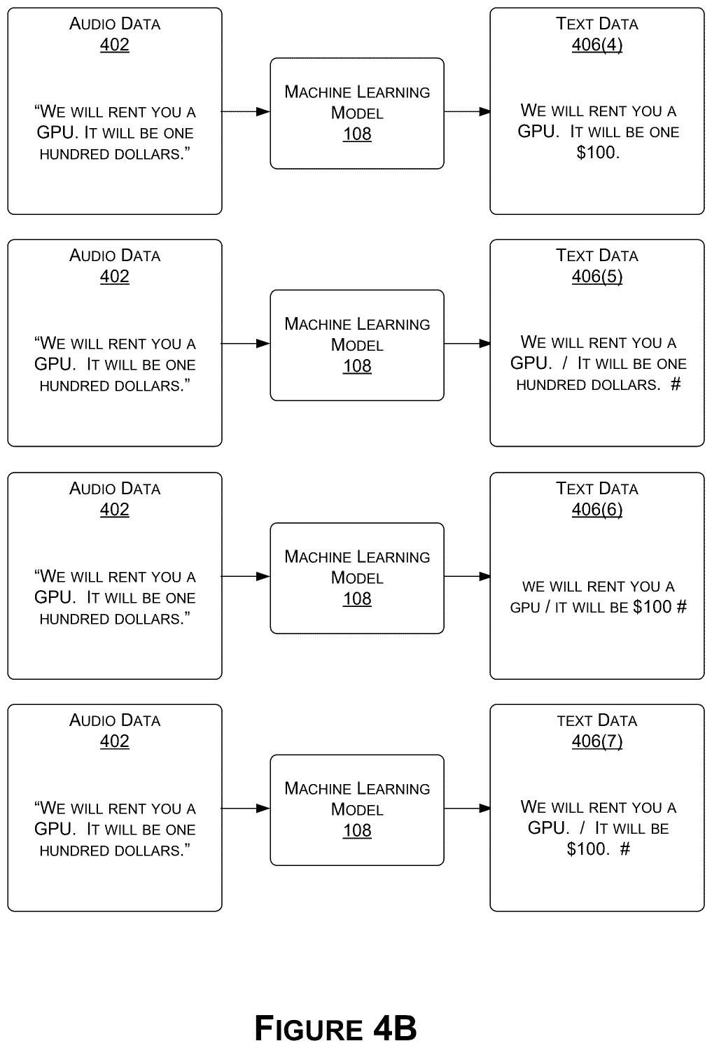

For instance, FIGS. 4A-4B illustrate examples of different types of processing that may be performed by the machine learning model 108, in accordance with some embodiments of the present disclosure. As shown, in each of the examples of FIGS. 4A-4B, the machine learning model 108 may process audio data 402, which includes the utterance “We will rent you a GPU. It will be one hundred dollars.” As such, for the first example, the machine learning model 108 may only be trained to perform ASR processing. As such, the machine learning model 108 may be used to generate text data 404(1) representing text (referred to as “ASR text”) that includes “we will rent you a gpu it will be one hundred dollars.” Next, for a second example, the machine learning model 108 may be trained to perform both ASR processing and ITN processing. As such, the machine learning model 108 may be used to generate first text data 406(1) representing first unified text that includes “we will rent you a gpu it will be $100.” In this second example, the first unified text includes “$100” instead of the “one hundred dollars” from the ASR text from the first example.

Next, for a third example, the machine learning model 108 may be trained to perform both ASR processing and PAC processing. As such, the machine learning model 108 may be used to generate second text data 406(2) representing second unified text that includes “We will rent you a GPU. It will be one hundred dollars.” In this third example, the second unified text includes the correct punctuation and capitalization as compared to the ASR text from the first example. Next, for a fourth example, the machine learning model 108 may be trained to perform both ASR processing and EOS/EOU processing. As such, the machine learning model 108 may be used to generate third text data 406(3) representing third unified text that includes “we will rent you a gpu/it will be one hundred dollars #.” In this fourth example, the third unified text includes the “/” symbol to indicate the EOS and the “#” symbol to indicate the EOS as compared to the ASR text from the first example. However, in other examples, unified text may include any other symbols to indicate the EOS and/or the EOU.

Next, for a fifth example, the machine learning model 108 may be trained to perform ASR processing, PAC processing, and ITN processing. As such, the machine learning model 108 may be used to generate fourth text data 406(4) representing fourth unified text that includes “We will rent you a GPU. It will be $100.” In this fifth example, the fourth unified text includes the correct punctuation, the correct capitalization, and “$100” as compared to the ASR text from the first example. Next, for a sixth example, the machine learning model 108 may be trained to perform ASR processing, PAC processing, and EOU/EOS processing. As such, the machine learning model 108 may be used to generate fifth text data 406(5) representing fifth unified text that includes “We will rent you a GPU./It will be one hundred dollars. #.” In this sixth example, the fifth unified text includes the correct punctuation, the current capitalization, the “/” symbol to indicate the EOS, and the “#” symbol to indicate the EUS as compared to the ASR text from the first example.

Next, for a seventh example, the machine learning model 108 may be trained to perform ASR processing, EOU/EOS processing, and ITN processing. As such, the machine learning model 108 may be used to generate sixth text data 406(6) representing sixth unified text that includes “we will rent you a GPU/it will be $100 #.” In this seventh example, the sixth unified text includes the “/” symbol to indicate the EOS, the “#” symbol to indicate the EOU, and “$100” as compared to the ASR text in the first example. Finally, for an eighth example, the machine learning model 108 may be trained to perform ASR processing, PAC processing, EOU/EOS processing, and ITN processing. As such, the machine learning model 108 may be used to generate seventh text data 406(7) representing seventh unified text that includes “We will rent you a GPU./It will be $100. #.” In this eighth example, the seventh unified text includes the correct punctuation, the correct capitalization, the “/” symbol to indicate the EOS, and the “#” symbol to indicate the EOU, and “$100” as compared to the ASR text in the first example.

FIG. 1B illustrates an example of a machine learning model 122 (which may be similar to, and/or represent, the machine learning model 108) that may be trained to generate unified text, in accordance with some embodiments of the present disclosure. As shown, the audio data 104 may be input directly into the machine learning model 122. The machine learning model 122 may then include an encoder 124 that is configured to process the audio data 104 and generate embeddings 126 associated with frames of the audio data 104, such as similar to the audio processor(s) 102. Additionally, the machine learning model 122 may include a decoder 128 that is configured to process the embeddings 126 and, based at least on the processing, generate output data 130 associated with speech. As described herein, the decoder 128 may include, but is not limited to, a recurrent neural network decoder, a connectionist temporal classification decoder, a transformer decoder, and/or any other type of decoder. Additionally, the output data 130 may represent tokens, similar to the output data 110, and/or the output data 130 may represent unified text, such as similar to the text data 118.

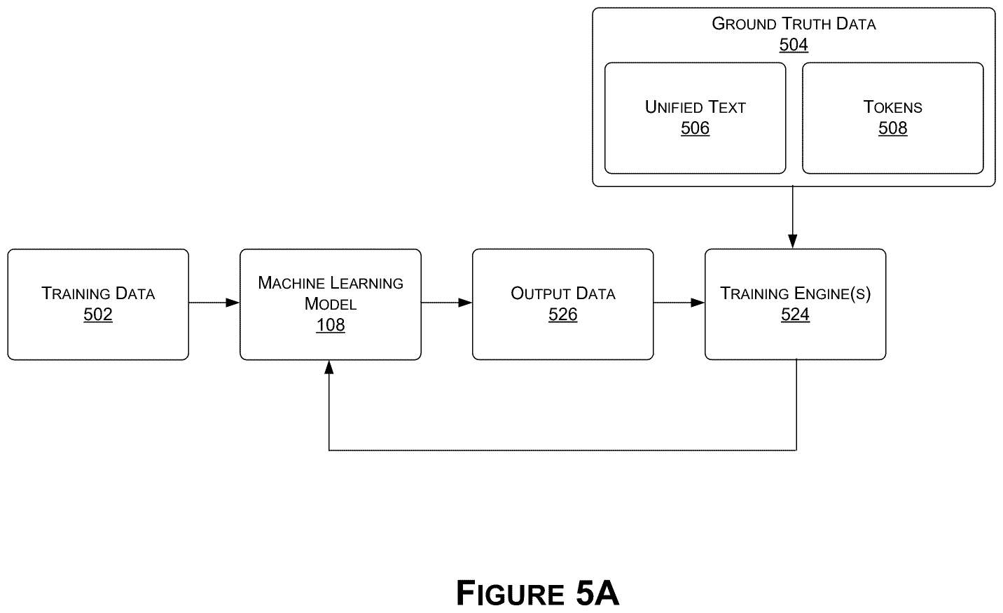

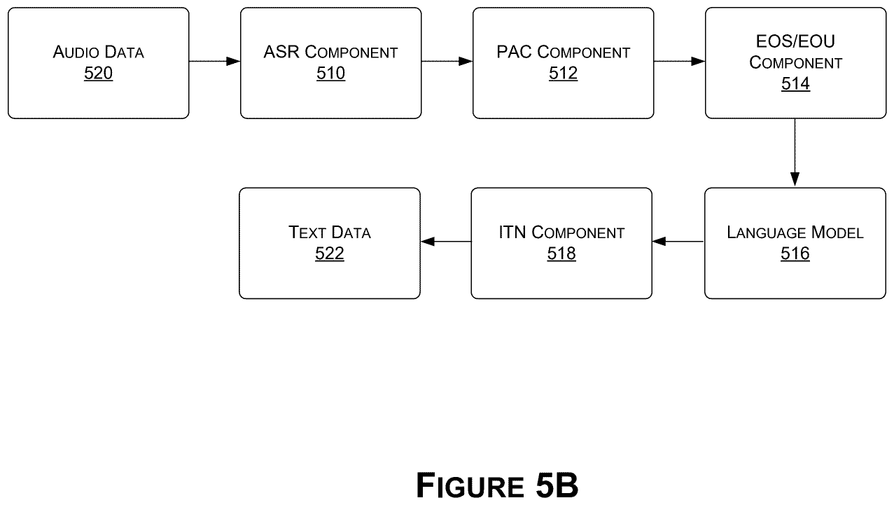

As described herein, the machine learning model 108 may be trained to perform various types of processing, such as ASR processing PAC processing, EOS/EOU processing, and/or ITN processing. As such, FIG. 5A illustrates a data flow diagram illustrating a process for training the machine learning model 108 to perform various types of processing, in accordance with some embodiments of the present disclosure. As shown, the machine learning model 108 may be trained using training data 502. In some examples, the training data 502 may include instances of speech (e.g., utterances), similar to the audio data 104, and/or vectors and/or embeddings associated with the instances of speech, similar to the input data 106. The training data 502 may be synthetically produced (e.g., generated from computer models or renderings), real produced (e.g., designed and produced from real-world data, such as audio data representing user speech), and/or a combination thereof.

The machine learning model 108 may be trained using the training data 502 as well as corresponding ground truth data 504. As shown, in some examples, the ground truth data 504 may include unified text 506 that corresponds to the instances of speech associated with the training data 502. Additionally, or alternatively, in some examples, the ground truth data 504 may include tokens 508 that are associated with the unified text 506, such as ASR tokens, PAC tokens, EOU/EOS tokens, and/or ITN tokens. As described herein, the ground truth data 504 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert), and/or a combination thereof. In some examples, for each instance of the training data 502 (e.g., each instance of speech, such as each utterance), there may be corresponding ground truth data 504.

For instance, in some examples, the training data may be obtained by using human listeners and linguistics to transcribe audio recordings into written form unified text which contains punctuation, capitalization, ends of sentences, ends of utterance, and inverse text normalization. Additionally, or alternatively, in some examples, the training data may be obtained using systems from a production grade state-of-the-art models where this system process the audio data into sequential manner to predict text, and then predict punctuations and capitalizations, then end of sentence and end of utterance, and then inverse text normalization or any other order of processing. Still, in some examples, a hybrid approach based on cascade of systems and human-in-the-loop verification for randomly selected training examples to ensure accurate ground-truth for training data may be used to obtain the training data.

For instance, FIG. 5B illustrates an example of generating the ground truth data 504 for training the machine learning model 108, in accordance with some embodiments of the present disclosure. As shown, the ground truth data 504 may be generated using a series of processing components, such as an ASR component 510 that is configured to perform ASR processing, a PAC component 512 that is configured to perform PAC processing, an EOS/EOU component 514 that is configured to perform EOS/EOU processing, a language model 516, and/or a ITN component 518 that is configured to perform ITN processing.

For example, audio data 520 (which may represent, and/or be similar to, the training data 502) may initially be processed using the ASR component 510 in order to generate text in spoken form, such as the first text data 404(1) from the example of FIG. 4A. The text may then be processed using the PAC component 512 in order to insert punctuation into the text and correct the text such it is in capitalization form, such as similar to the second text data 406(2) from the example of FIG. 4A. Next, the text may be processed using the EOS/EOU component 514 that is configured to determine the ends of sentences and/or the ends of utterances associated with the text, such as similar to the fifth text data 406(5) form the example of FIG. 4B. After detecting the ends of sentences and/or ends of utterances, the text may be processed using the language model 516, such as to correct the text if there are any mistakes from the ASR component 510 and/or to improve the structure of the text. Finally, the text may be processed using the ITN component 518 that is configured to perform ITN processing, such as by converting the spoken form words to written form, such as similar to the seventh text data 406(7) from the example of FIG. 4B. The output from the processing may then include text data 522 representing unified text.

While the example of FIG. 5B illustrates processing the audio data 520 using each of the ASR component 510, the PAC component 512, the EOS/EOU component 514, the language model 516, and the ITN processing 518, in other examples, the audio data 520 may be processed using one or more of the ASR component 510, the PAC component 512, the EOS/EOU component 514, the language model 516, and the ITN component 518. For instance, the processing that is performed on the audio data 520 may be based on how the machine learning model 108 is being trained. For a first example, if the machine learning model 108 is just being trained to perform ASR processing and ITN processing, then the audio data 520 may just be processed using the ASR component 510 and the ITN component 518, such as to generate unified text that is similar to the unified text represented by the first text data 106(1) from the example of FIG. 4A. For a second example, if the machine learning model 108 is being trained to perform ASR processing, PAC processing, and ITN processing, then the audio data 520 may just be processed using the ASR component 510, the PAC component 512, and the ITN component 518, such as to generate unified text that is similar to the unified text represented by the fourth text data 106(4) from the example of FIG. 4B.

Referring back to the example of FIG. 5A, to train the machine learning model 108, one or more training engines 524 may use one or more loss functions that measure loss (e.g., error) in outputs 526 as compared to the ground truth data 504. As described herein, in some examples, such as when the ground truth data 504 represents the instances of unified text 506, the outputs 526 may also include instances of unified text as determined using the machine learning model 108 processing the audio data 520. As such, the training engine(s) 524 may compare the instances of unified text 506 to the instances of text from the outputs 526 to measure the loss(es). Additionally, or alternatively, in some examples, such as when the ground truth data 504 represents the tokens 508, the outputs 526 may also include tokens as determined by the machine learning model processing the audio data 520. As such, the training engine(s) 524 may compare the tokens 508 to the tokens from the outputs 526 to measure the loss(es).

For instance, a loss function may be used for the unified ground truth (unified tokens). Specifically, markers (e.g., symbols) associated with PAC, EOS, EOU, and/or ITN may be inserted into the ground truth text to obtain the unified text 506. Next, unified tokens 508 may be generated to represent the unified text 506 with the inserted markers such that the unified tokens 508 also represent the PAC, EOS, EOU, and/or ITN. As such, the loss function may then be computed using predicted tokens represented by the output data 526 and the unified tokens 508 represented by the ground truth data 504. Any type of loss function may then be used, such as cross-entropy loss, mean squared loss, or any other type of loss.

In any of these examples, any type of loss function may be used. For instance, differential function of unified ground-truth text and predicted unified text can serve as loss function depending on use case and training data. Additionally, in some examples, there is no restriction on choice of loss function for the proposed approach. Some of the loss which may be used are Connectionist Temporal Classification (CTC) Loss, RNN-Transducer (RNN-T) loss, Cross-Entropy Loss, Sequence-to-Sequence Losses, Lattice-Free Maximum Mutual Information (LF-MMI), Minimum Word Error Rate (MWER) Loss, Minimum Bayes Risk (MBR) Loss or a weighted combination of these losses. For building our prototype system, a hybrid loss which is weighted combination of CTC loss and RNN-T loss computed on unified ground-truth text and predictions may be used.

In some examples, different outputs 526 may have different loss functions. For example, the ASR tokens 508 and/or the unified text 506 associated with ASR processing may use a first loss function, the PAC tokens 508 and/or the unified text 506 associated with PAC processing may use a second loss function, the EOS/EOU tokens 508 and/or the unified text 506 associated with EOS/EOU processing may use a third loss function, and/or the ITN tokens 508 and/or the unified text 506 associated with ITN processing may use a fourth loss function. In such examples, the loss functions may be combined to form a total loss (where one or more losses may be weighted), and the total loss may be used to train (e.g., update the parameters of) the machine learning model 108. In any example, backward pass computations may be performed to recursively compute gradients of the loss function(s) with respect to training parameters. In some examples, weights and/or biases of the machine learning model 108 may be used to compute these gradients.

As described herein, the machine learning model 108 may be trained to perform one or more specific types of processing. For a first example, if the machine learning model 108 is being trained to perform ASR processing and ITN processing, then the ground truth data 504 may be specific to ASR processing and ITN processing, such that the unified text 506 may at least be in ITN formatting and/or the tokens 508 may include ITN tokens. As such, the training engine(s) 524 may determine the loss(es) associated with at least ITN processing, such as using a word error rate associated with ITN. For a second example, if the machine learning model 108 is being trained to perform ASR processing, PAC processing, and ITN processing, then the ground truth data may be specific to ASR processing, PAC processing, and ITN processing, such that the unified text may include punctuation marks, capitalizations, and be in ITN formatting and/or the tokens 508 may include at least PAC tokens and ITN tokens. As such, the training engine(s) 524 may determine a first loss(es) associated with PAC processing using a first word error rate and a second loss(es) associated with ITN processing using a second word error rate.

In some examples, different machine learning models 108 may be generated and/or trained for different languages and/or a single machine learning model may be used for multiple languages. For instance, English and non-English languages monolingual models (one ASR model for each language-locale) or multi-lingual models (one ASR model for more than one language) may be generated. For example, en-US ASR model will be a monolingual model focused on US English. En-GB ASR model will be monolingual focused on British English, and/or so forth. For another example, a multi-lingual ASR model for the regions of Europe, the Middle East, and Africa may be developed for popular languages in these regions which are English, French, German, Dutch, Italian, Spanish, Portuguese, Arabic, Swahili, and/or so forth. In other words, there may be no limit on number of models a multi-lingual models may support. For multi-lingual models, EOS/EOU tags token may be needed to be distinct from the superset of punctuation symbols used in all of the languages served by the multi-lingual model.

In some examples, a machine learning model 108 may be generated and/or trained to perform code-switching. Code-switched scenarios refer to situations where a user speaks in a first language, then switches to a second language, and then comes back to the first language or keeps speaking the second language. In some circumstances, there is no limit on the number of different languages being spoken in a code-switched utterance. Additionally, in some circumstances, there is no limit on the number of times the language is switched or changed in an utterance. For example, a user may talk in English for 2 minutes, switch to German for next 2 minutes, and then switch again to English for 1 minute. In such an example, a unified ASR model for code-switched scenarios may output the unified text corresponding to the spoken language and text, where the switch in output language is automatic. Additionally, the unified ASR model may learn this during training where code-switched audio and corresponding ground truth text is used to train/teach the unified ASR model to recognize unified text from audio.

In some examples, sets of punctuation symbols may be selected for representing outputs based on how a developer wants to train a machine learning model(s) 108 and/or based on different languages for which machine learning models 108 are being trained. For instance, a developer may choose some special ways to denote punctuations. For example, a developer may choose to use two-spaces for comma, three-space for period, four-spaces for question marks, or a dash for exclamation mark. As such, by performing one or more of the processes described herein, the machine learning model(s) 108 may be trained to generate text that includes the sets of punctuation symbols. For example, the ground truth data 504 that is used to train the machine learning model(s) 108 may include the set of punctuation marks for which a developer desires in unified text such that the machine learning model(s) 108 learns the set of punctuation marks during training.

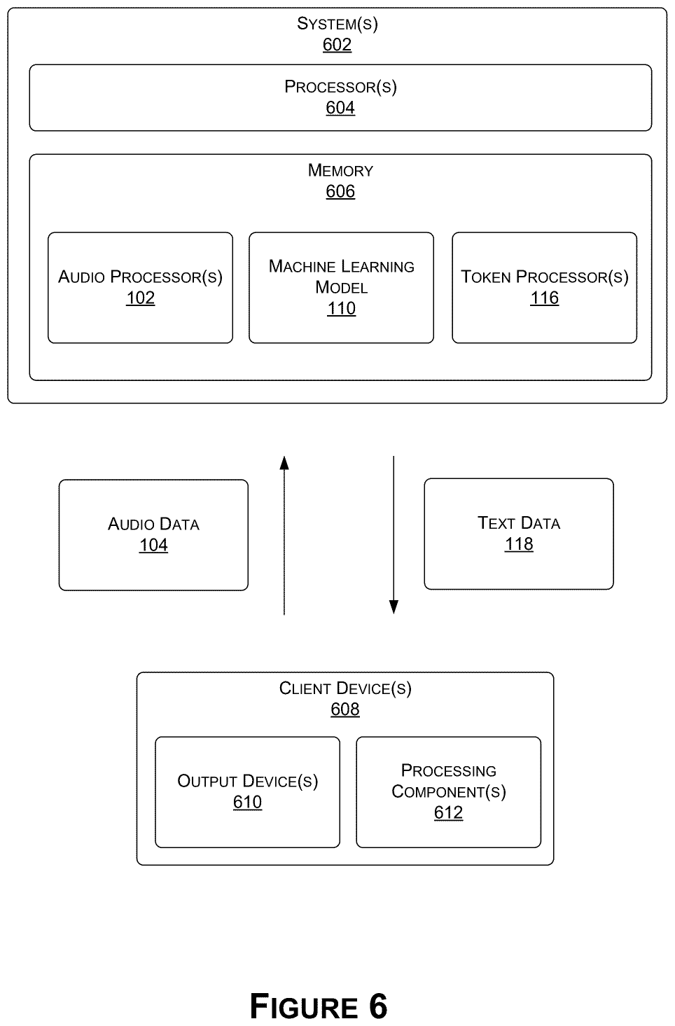

FIG. 6 illustrates an example of a system 602 that may perform one or more of the processes described herein, in accordance with some embodiments of the present disclosure. As shown, the system 602 (which may represent, and/or include, an example computing device(s) 1000 and/or an example data center 1100) may include one or more processors 604 (which may be similar to, and/or include, one or more central processing units 1006 and/or one or more graphics processing units 1008) and memory 606 (which may be similar to, and/or include, a memory 1004). For instance, the memory 606 may store the audio processor(s) 102, the machine learning model 108, and the token processor(s) 116. Additionally, the processor(s) 604 may execute the audio processor(s) 102, the machine learning model 108, and/or the token processor(s) 116 to perform one or more of the processes described herein.

Additionally, as shown by the example of FIG. 6, the system 602 may receive the audio data 104 from one or more client device 608 (which may also be similar to, and/or include, an example computing device 1000) and/or send the text data 118 to the client device(s) 608. For instance, the client device(s) 608 may use one or more input devices, such as one or more microphones, to generate the audio data 104. After generating the audio data 104, the client device(s) 608 may send the audio data 104 to the system 602 for processing.

Additionally, the client device(s) 608 may perform one or more processes using the text data 118. For a first example, after receiving the text data 118, the client device(s) 608 may use one or more output devices 610 to provide the unified text, such as a display that presents the unified text. For a second example, after receiving the text data 118, the client device(s) 608 may use one or more additional processing components 612 that are configured to further process the unified text. For instance, the processing component(s) 612 may process the unified text using one or more natural language understanding applications, machine translation applications, and/or any other type of processing application. While the example of FIG. 6 illustrates the client device(s) 608 as including the processing component(s) 612, in other examples, the system(s) 602 may include the processing component(s) 612.

In some examples, the machine learning model 108 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model 108 is small enough (e.g., has a small enough number of parameters), the model may be included within the container itself. In some embodiments, the machine learning model 108 described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model 108 described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model 108 and provide outputs/responses to inputs (e.g., user queries, prompts, etc.), and enterprise management software to provide health checks, identity, and other monitoring. In some embodiments, the inference microservice may include software to perform in-place replacement and/or updating to the machine learning model 108. When replacing or updating, the software that performs the replacement/updating may maintain user configurations of the inference runtime software and enterprise management software.

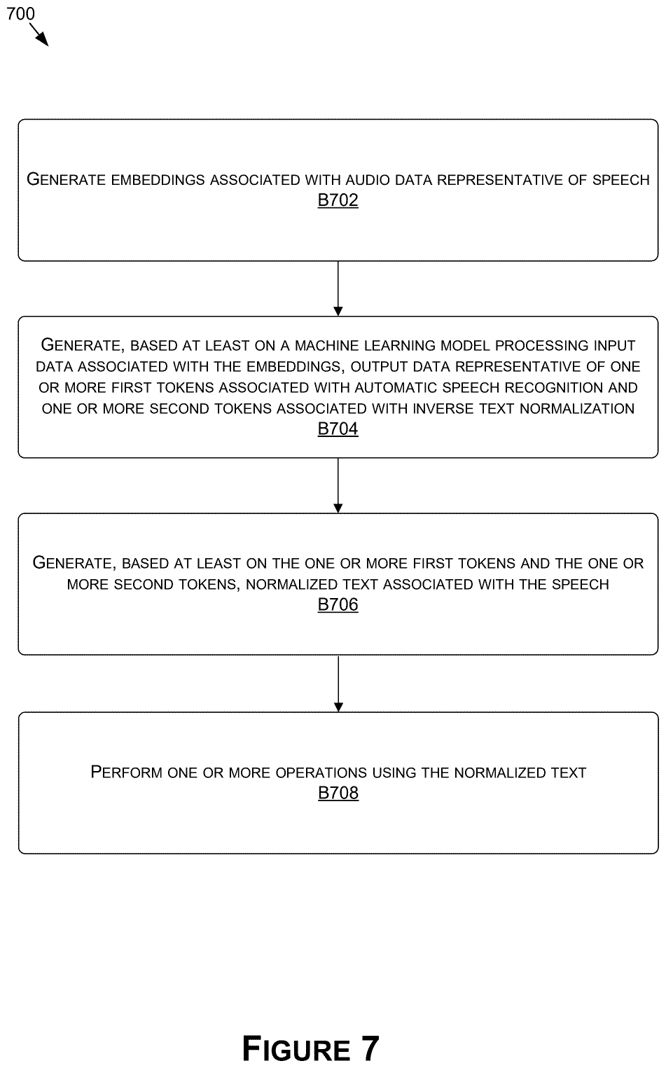

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods 600 and 700 may also be embodied as computer-usable instructions stored on computer storage media. The methods 600 and 700 may be provided by a standalone application, a service or hosted service (standalone or in combination with another hosted service), or a plug-in to another product, to name a few. In addition, the methods 600 and 700 are described, by way of example, with respect to FIG. 1A. However, these methods 600 and 700 may additionally or alternatively be executed by any one system, or any combination of systems, including, but not limited to, those described herein.

FIG. 7 illustrates a flow diagram showing a method 700 for processing audio data using a machine learning model that performs ASR processing and ITN processing, in accordance with some embodiments of the present disclosure. The method 700, at block B702, may include generating embeddings associated with audio data representative of speech. For instance, the audio processor(s) 102 may process the audio data 104 and, based at least on the processing, generate the input data 106 representing the embeddings. As described herein, the embeddings may be associated with frames of the audio data. Additionally, while the example of FIG. 1A illustrates the audio processor(s) 102 as being separate from the machine learning model 108, in other examples, the audio processor(s) 102 may include a portion of the machine learning model 108 (e.g., one or more encoders of the machine learning model 108).

The method 700, at block B704, may include generating, based at least on a machine learning model processing input data associated with the embeddings, output data representative of one or more first tokens associated with automatic speech recognition and one or more second tokens associated with inverse text normalization. For instance, the machine learning model 108 may process the input data 106 and, based at least on the processing, generate the output data 110 that represents the ASR token(s) 112(1) and the ITN token(s) 112(4). As described herein, in some examples, the output data 110 may further represent the PAC token(s) 112(2) and/or the EOS/EOU token(s) 112(3). Additionally, in some examples, the output data 110 may represent one or more probabilities 114(1) associated with the ASR token(s) 112(1) and/or one or more probabilities 114(4) associated with the ITN token(s) 112(4).

The method 700, at block B706, may include generating, based at least on the one or more first tokens and the one or more second tokens, normalized text associated with the speech. For instance, the token processor(s) 116 may use the ASR token(s) 112 and the ITN token(s) 112(4) to generate the normalized text (e.g., unified text), such as text that is in written form. Additionally, in some examples, the token processor(s) 116 may use the PAC token(s) 112(2) to generate the normalized text to include one or more punctuations marks and/or capitalizations and/or use the EOS/EOU token(s) 112(3) to generate the text to include one or more EOS symbols and/or one or more EOU symbols. While the example of FIG. 1A illustrates the token processor(s) 116 as being separate from the machine learning model 108, in other examples, the token processor(s) 116 may include a portion of the machine learning model 108 (e.g., one or more decoders of the machine learning model 108).

The method 700, at block B708, may include performing one or more operations using the normalized text. For instance, the one or more operations may include presenting the normalized text using one or more client devices, further processing the normalized text using one or more additional processing units (e.g., one or more applications), and/or performing any other type of operation.

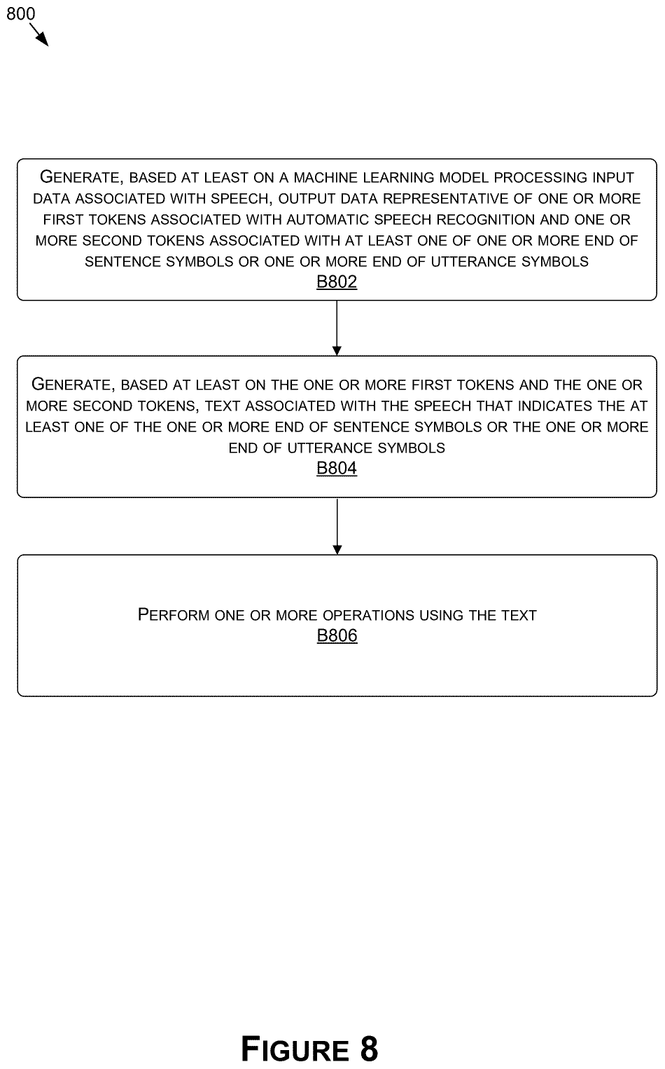

FIG. 8 illustrates a flow diagram showing a method 800 for processing audio data using a machine learning model that performs ASR processing and EOS and/or EOU processing, in accordance with some embodiments of the present disclosure. The method 800, at block B802, may include generating, based at least on a machine learning model processing input data associated with speech, output data representative of one or more first tokens associated with automatic speech recognition and one or more second tokens associated with at least one of one or more end of sentence symbols or one or more end of utterance symbols. For instance, the machine learning model 108 may process the input data 106 (and/or the audio data 104) and, based at least of the processing, generate the output data 110 that represents the ASR token(s) 112(1) and the EOS/EOU token(s) 112(3). As described herein, in some examples, the output data 110 may further represent the PAC token(s) 112(2) and/or the ITN token(s) 112(4). Additionally, in some examples, the output data 110 may represent one or more probabilities 114(1) associated with the ASR token(s) 112(1) and/or one or more probabilities 114(3) associated with the EOS/EOU token(s) 112(3).

The method 800, at block B804, may include generating, based at least on the one or more first tokens and the one or more second tokens, text associated with the speech, the text including at least one of the one or more end of sentence symbols or the one or more end of utterance symbols. For instance, the token processor(s) 116 may use the ASR token(s) 112 and the EOS/EOU token(s) 112(3) to generate the text (e.g., unified text), where the text includes the EOS symbol(s) and the EOU symbol(s). Additionally, in some examples, the token processor(s) 116 may use the PAC token(s) 112(2) to generate the text to include one or more punctuations marks and/or capitalizations and/or use the ITN token(s) 112(4) to generate the text to include the normalized format.

The method 800, at block B806, may include performing one or more operations using the text. For instance, the one or more operations may include presenting the text using one or more client devices, further processing the text using one or more additional processing units (e.g., one or more applications), and/or performing any other type of operation.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

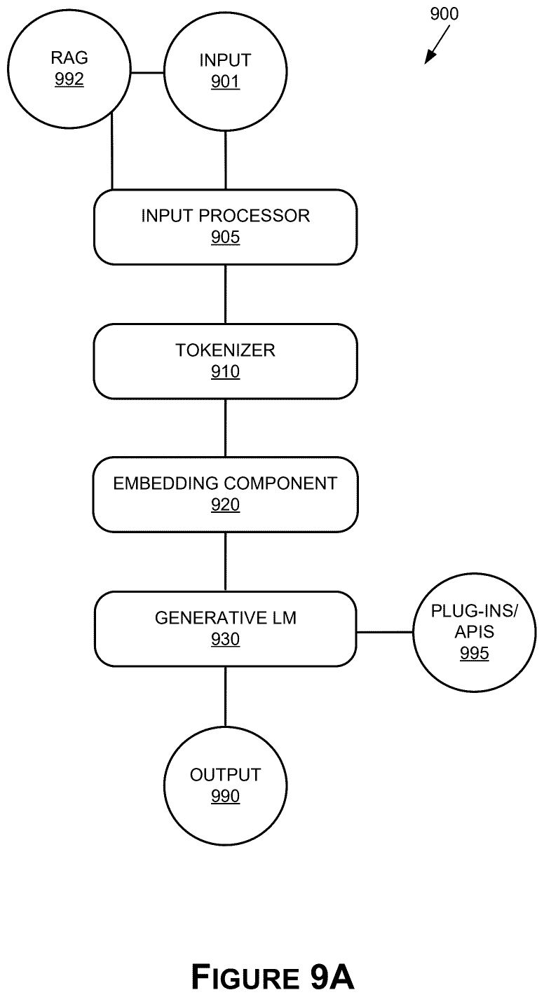

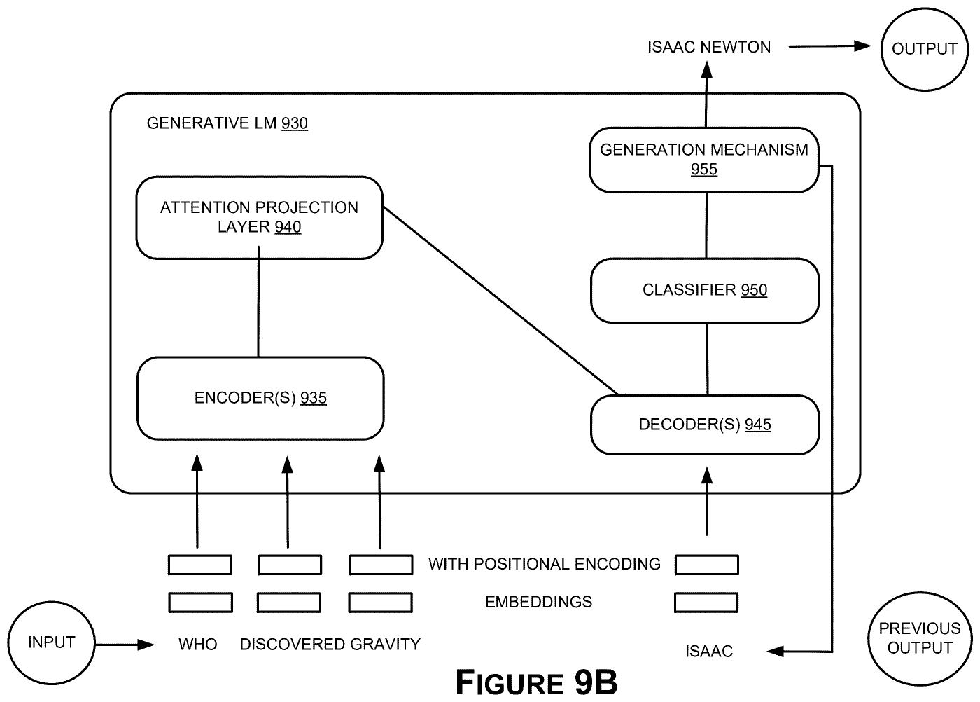

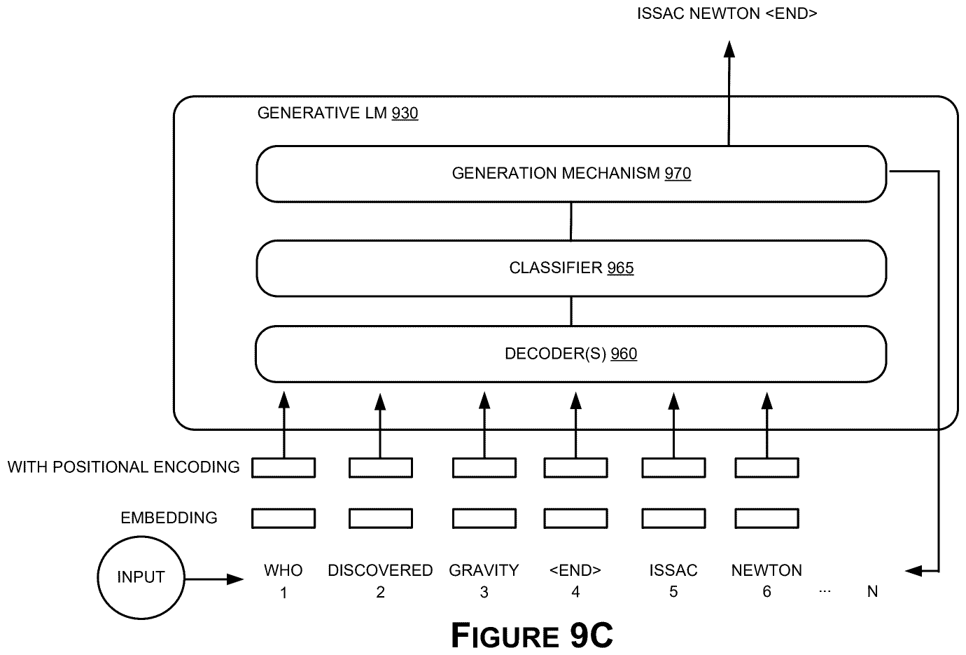

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

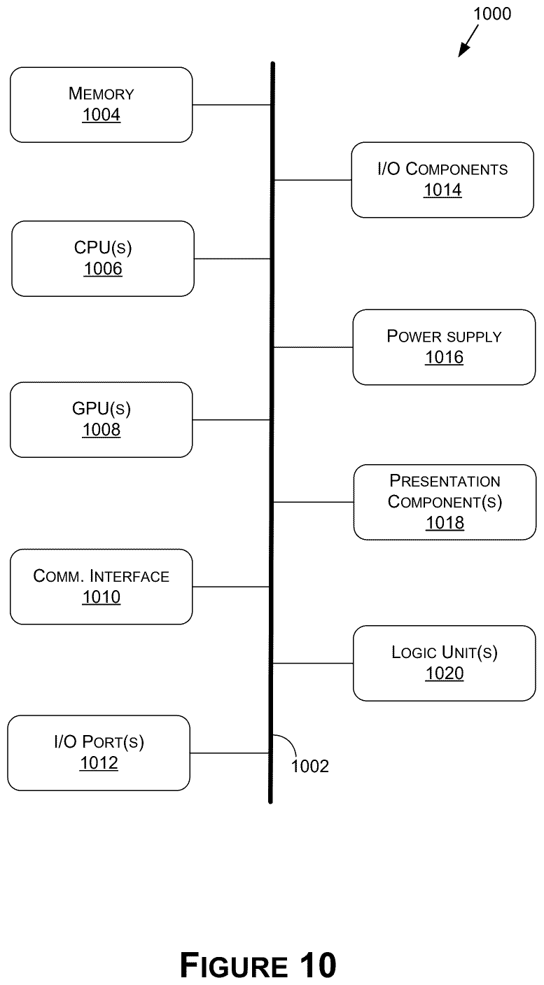

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

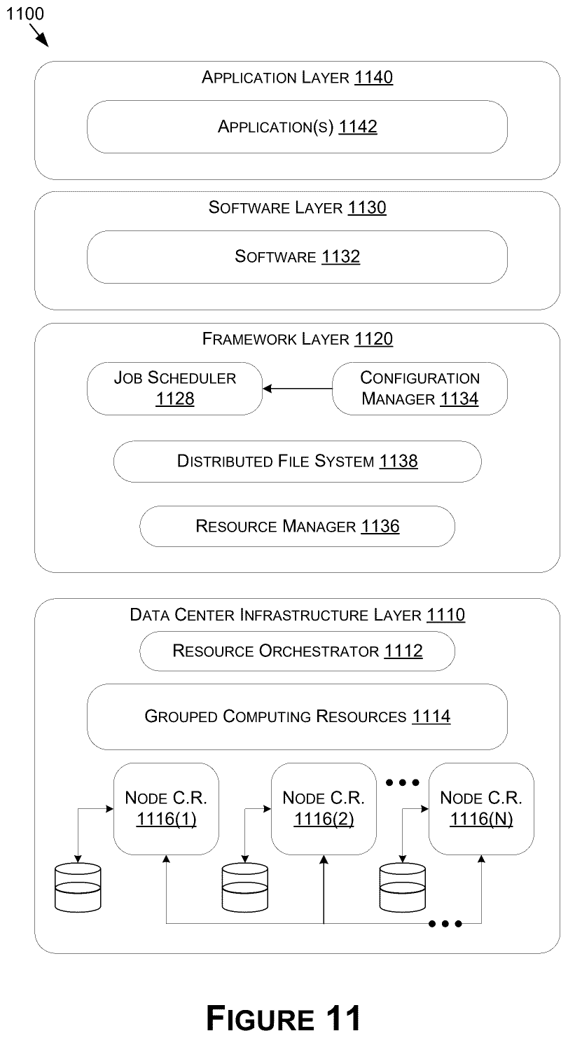

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating audio embeddings associated with audio data representative of user speech; generating, based at least on a machine learning model processing input data associated with the audio embeddings, output data representative of tokens associated with the user speech, at least a first portion of the tokens being associated with automatic speech recognition and at least a second portion of the tokens being associated with inverse text normalization; generating, based at least on the tokens, normalized text that represents the user speech; and performing one or more operations using the normalized text.
B: The method of paragraph A, wherein: at least a third portion of the tokens is associated with at least one of an end of sentence or an end of utterance; and the normalized text includes at least one of a first indication of the end of sentence or a second indication of the end of utterance.
C: The method of either paragraph A or paragraph B, wherein: at least a third portion of the tokens is associated with at least one of one or more punctuation marks or one or more capital letters; and the normalized text includes the at least one of the one or more punctuation marks or the one or more capital letters.
D: The method of any one of paragraphs A-C, wherein: the output data further represents probabilities associated with the tokens; and the generating the normalized text that represents the user speech is further based at least on the probabilities.
E: The method of any one of paragraph A-D, wherein: at least the first portion of the tokens that is associated with the automatic speech recognition includes at least one of: one or more first tokens representing one or more letters; one or more second tokens representing one or more portions of one or more first words; or one or more third tokens representing one or more second words; and at least the second portion of the tokens that is associated with the inverse text normalization includes at least one of: one or more fourth tokens representing one or more numbers; or one or more fifth tokens representing one or more symbols associated with one or more third words.
F: The method of any one of paragraphs A-E, wherein the tokens are associated with one or more first frames of the audio data, and wherein the method further comprises: generating, based at least on the machine learning model processing the input data, second output data representative of second tokens associated with the user speech, at least a first portion of the second tokens being associated with the automatic speech recognition and at least a second portion of the second tokens being associated with the inverse text normalization, wherein the generating the normalized text that represents the user speech is further based at least on the second tokens.
G: The method of any one of paragraphs A-F, wherein the performing the one or more operations using the normalized text comprises at least one of: causing at least a portion of the normalized text to be processed using one or more second machine learning models; or causing presentation of an output associated with at least a portion of the normalized text.
H: The method of any one of paragraphs A-G, further comprising: obtaining second audio data representative of second user speech and ground truth data representative of one or more second tokens associated with the second user speech, at least a portion of the one or more second tokens being associated with the inverse text normalization; generating one or more second audio embeddings associated with the second audio data; generating, based at least on the machine learning model processing second input data associated with the one or more second audio embeddings, second output data representative of one or more third tokens associated with the second user speech; and updating one or more parameters associated with the machine learning model based at least on the one or more third tokens and the one or more second tokens.
I: A system comprising: one or more processors to: generate, based at least on a machine learning model processing input data associated with user speech, output data representative of: one or more first tokens representative of at least one or more letters; and one or more second tokens representative of one or more numbers or one or more symbols that represent one or more words; generate, based at least on the one or more first tokens and the one or more second tokens, text that represents the user speech and includes the one or more numbers or the one or more symbols; and perform one or more operations using the text.
J: The system of paragraph I, wherein the one or more processors are further to generate, based at least on audio data representative of the user speech, the input data representative of one or more embeddings corresponding to one or more frames associated with the audio data.
K: The system of either paragraph I or paragraph J, wherein: the one or more second tokens are associated with inverse text normalization; and the text includes normalized text corresponding to the user speech.
L: The system of claim of any one of paragraphs I-K, wherein: the output data further represents one or more third tokens that are associated with at least one of an end of sentence or an end of utterance; and the text that represents the user speech is further generated based at least on the one or more third tokens and includes at least one of a first indication of the end of sentence or a second indication of the end of utterance.
M: The system of claim of any one of paragraphs I-L, wherein: the output data further represents one or more third tokens that are associated with one or more punctuation marks; and the text that represents the user speech is further generated based at least on the one or more third tokens and includes the one or more punctuation marks.
N: The system of any one of paragraphs I-M, wherein: the output data is further representative of one or more first probabilities associated with the one or more first tokens and one or more second probabilities associated with the one or more second tokens; and the text that represents the user speech is further generated based at least on the one or more first probabilities and the one or more second probabilities.
O: The system of any one of paragraphs I-N, wherein: the output data is associated with one or more first frames of audio data that represents the user speech; the one or more processors are further to generate, based at least on the machine learning model processing the input data, second output data associated with one or more second frames of the audio data, the second output data representative of one or more third tokens representative of at least one of the one or more numbers or the one or more symbols that represent the one or more words; and the text is further generated based at least on the one or more third tokens.
P: The system of any one of paragraphs I-O, wherein the performance the one or more operations using the text comprises at least one of: causing at least a portion of the text to be processed using one or more second machine learning models; or causing an output associated with at least a portion of the text.
Q: The system of any one of paragraphs I-P, wherein the machine learning model includes at least: one or more encoders for processing the audio data in order to generate the input data; and one or more decoders for processing the input data in order to generate the output data representative of the one or more first tokens and the one or more second tokens.
R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
S: One or more processors comprising: processing circuitry to generate normalized text associated with user speech based at least on one or more tokens, wherein the one or more tokens are generated based at least on: an encoder associated with a machine learning model processing audio data representative of the user speech in order to generate a first output; and a decoder associated with the machine learning model processing the first output in order to generate a second output representative of the one or more tokens.
T: The one or more processors of paragraph S, wherein the machine learning model is deployed as an inference microservice that includes the machine learning model and an operating system (OS)-level virtualization package, the OS-level virtualization package including software for executing the machine learning model and enterprise management software for performing one or more telemetry operations with respect to the machine learning model.

What is claimed is:

1. A method comprising:
generating audio embeddings associated with audio data representative of user speech;
generating, based at least on a machine learning model processing input data associated with the audio embeddings, output data representative of tokens associated with the user speech, at least a first portion of the tokens being associated with automatic speech recognition and at least a second portion of the tokens being associated with inverse text normalization;
generating, based at least on the tokens, normalized text that represents the user speech; and
performing one or more operations using the normalized text.

2. The method of claim 1, wherein:
at least a third portion of the tokens is associated with at least one of an end of sentence or an end of utterance; and
the normalized text includes at least one of a first indication of the end of sentence or a second indication of the end of utterance.

3. The method of claim 1, wherein:
at least a third portion of the tokens is associated with at least one of one or more punctuation marks or one or more capital letters; and
the normalized text includes the at least one of the one or more punctuation marks or the one or more capital letters.

4. The method of claim 1, wherein:
the output data further represents probabilities associated with the tokens; and
the generating the normalized text that represents the user speech is further based at least on the probabilities.

5. The method of claim 1, wherein:
at least the first portion of the tokens that is associated with the automatic speech recognition includes at least one of:
one or more first tokens representing one or more letters;
one or more second tokens representing one or more portions of one or more first words; or
one or more third tokens representing one or more second words; and
at least the second portion of the tokens that is associated with the inverse text normalization includes at least one of:
one or more fourth tokens representing one or more numbers; or
one or more fifth tokens representing one or more symbols associated with one or more third words.

6. The method of claim 1, wherein the tokens are associated with one or more first frames of the audio data, and wherein the method further comprises:
generating, based at least on the machine learning model processing the input data, second output data representative of second tokens associated with the user speech, at least a first portion of the second tokens being associated with the automatic speech recognition and at least a second portion of the second tokens being associated with the inverse text normalization,
wherein the generating the normalized text that represents the user speech is further based at least on the second tokens.

7. The method of claim 1, wherein the performing the one or more operations using the normalized text comprises at least one of:
causing at least a portion of the normalized text to be processed using one or more second machine learning models; or
causing presentation of an output associated with at least a portion of the normalized text.

8. The method of claim 1, further comprising:
obtaining second audio data representative of second user speech and ground truth data representative of one or more second tokens associated with the second user speech, at least a portion of the one or more second tokens being associated with the inverse text normalization;
generating one or more second audio embeddings associated with the second audio data;
generating, based at least on the machine learning model processing second input data associated with the one or more second audio embeddings, second output data representative of one or more third tokens associated with the second user speech; and
updating one or more parameters associated with the machine learning model based at least on the one or more third tokens and the one or more second tokens.

9. A system comprising:
one or more processors to:
generate, based at least on a machine learning model processing input data associated with user speech, output data representative of:
one or more first tokens representative of at least one or more letters; and
one or more second tokens representative of one or more numbers or one or more symbols that represent one or more words;
generate, based at least on the one or more first tokens and the one or more second tokens, text that represents the user speech and includes the one or more numbers or the one or more symbols; and
perform one or more operations using the text.

10. The system of claim 9, wherein the one or more processors are further to generate, based at least on audio data representative of the user speech, the input data representative of one or more embeddings corresponding to one or more frames associated with the audio data.

11. The system of claim 9, wherein:
the one or more second tokens are associated with inverse text normalization; and
the text includes normalized text corresponding to the user speech.

12. The system of claim of claim 9, wherein:
the output data further represents one or more third tokens that are associated with at least one of an end of sentence or an end of utterance; and
the text that represents the user speech is further generated based at least on the one or more third tokens and includes at least one of a first indication of the end of sentence or a second indication of the end of utterance.

13. The system of claim of claim 9, wherein:
the output data further represents one or more third tokens that are associated with one or more punctuation marks; and
the text that represents the user speech is further generated based at least on the one or more third tokens and includes the one or more punctuation marks.

14. The system of claim 9, wherein:
the output data is further representative of one or more first probabilities associated with the one or more first tokens and one or more second probabilities associated with the one or more second tokens; and
the text that represents the user speech is further generated based at least on the one or more first probabilities and the one or more second probabilities.

15. The system of claim 9, wherein:
the output data is associated with one or more first frames of audio data that represents the user speech;
the one or more processors are further to generate, based at least on the machine learning model processing the input data, second output data associated with one or more second frames of the audio data, the second output data representative of one or more third tokens representative of at least one of the one or more numbers or the one or more symbols that represent the one or more words; and
the text is further generated based at least on the one or more third tokens.

16. The system of claim 9, wherein the performance the one or more operations using the text comprises at least one of:
causing at least a portion of the text to be processed using one or more second machine learning models; or
causing an output associated with at least a portion of the text.

17. The system of claim 9, wherein the machine learning model includes at least:
one or more encoders for processing the audio data in order to generate the input data; and
one or more decoders for processing the input data in order to generate the output data representative of the one or more first tokens and the one or more second tokens.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to generate normalized text associated with user speech based at least on one or more tokens, wherein the one or more tokens are generated based at least on:
an encoder associated with a machine learning model processing audio data representative of the user speech in order to generate a first output; and
a decoder associated with the machine learning model processing the first output in order to generate a second output representative of the one or more tokens.

20. The one or more processors of claim 19, wherein the machine learning model is deployed as an inference microservice that includes the machine learning model and an operating system (OS)-level virtualization package, the OS-level virtualization package including software for executing the machine learning model and enterprise management software for performing one or more telemetry operations with respect to the machine learning model.
